(19) United States
(12) Patent Application Publication
(10) Pub. No.: US 2019/0306721 A1
(43) Pub. Date: Oct. 3, 2019

(54) A SYSTEM AND METHOD FOR ALLOCATING A WIRELESS CHANNEL USING A PLURALITY OF ACCESS POINTS

(71) Applicant: RELIANCE JIO INFOCOMM LIMITED, Mumbai, Maharashtra (IN)

(72) Inventors: Ajay Kumar GUPTA, Pune - Maharashtra (IN); Vishal OAK, Bangalore - Karnataka (IN); Thomas SCHLANGEN, Chandler, AZ (US); Tareq AMIN, Mission Viejo, CA (US)

(21) Appl. No.: 16/306,669

(22) PCT Filed: Jun. 2, 2017
(86) PCT No.: PCT/IB2017/053266

§ 371 Date: Dec. 3, 2018

(30) Foreign Application Priority Data
Jun. 10, 2016 (IN) 201621020050

(51) Int. Cl. H04W 16/10; H04W 72/08

(52) U.S. Cl. CPC H04W 16/10; H04W 88/08; H04W 72/08

(57) ABSTRACT

Embodiments of the present disclosure relate to allocating at least one wireless channel to an access point [for e.g. 102A] by an access point itself [for e.g. 102A]. In one embodiment, a method is disclosed comprising: detecting at least one neighbouring access point [for e.g. 102B, 102C and 102D]; selecting at least one target wireless channel having the highest comparative associated channel width; transmitting a request message to each of the at least one neighbouring access point [for e.g. 102B, 102C and 102D] and allocating the at least one target wireless channel if each of the at least one target wireless channel having the associated channel width is acceptable to the at least one neighbouring access point [for e.g. 102B, 102C and 102D].

### TECHNICAL FIELD

The present disclosure generally relates to wireless communication systems and is more specifically directed to optimal channel allocation to a plurality of access points in a wireless spectrum.

### BACKGROUND

In recent years, technologies such as Wi-Fi based on IEEE 802.11 standards have undergone tremendous growth and commercialization. In current market scenario, nearly all available user equipment (UE) with cellular capability support are integrated with Wi-Fi capability to connect with available Wi-Fi networks operating in the unlicensed frequency bands such as 2.4 GHz, or 5 GHz.

Implementation of 802.11ac and 802.11n with IEEE 802.11 standard (known as Wi-Fi) has enabled consumers to achieve high data rates over a wireless local network by utilizing wider channel widths. These wider channel widths specified in such implementations, such as 40 MHz, 80 MHz, 160 MHz, and 80 MHz, may be achieved via channel bonding on multiple consecutive or non-consecutive standard 20 MHz wide channels units (as proposed in early IEEE 802.11 standards, 802.11a/g) available in a wireless band.

Consequently, while allocating/assigning channels to a plurality of wireless access points (compliant to 802.11ac standard) for providing wireless services in a particular area, appropriate/optimal width constrained channels need to be selected for each access point available within the coverage. This, not only minimizes the conflict between access points due to overlapping channel widths, but also maximizes the utilization of available wireless band via wider channels, thereby improving the overall throughput of the wireless network.

Further, there exists several known solutions for using wider channel widths (specified in 802.11n and 802.11ac standards) in an optimum manner. One of the existing wireless solutions provide a static configuration to facilitate a fixed channel width mode to a plurality of access points providing wireless services in a particular area, wherein said width may be one of 160 MHz, 80 MHz, 40 MHz, 20 MHz and any such channel width that is currently available with the 802.11ac standard.

An exemplary case of a typical network area comprises of four wireless access points deployed in hotspot areas for providing wireless services in the area to the users, wherein the access points operate on either of the different wireless channel widths specified in the 802.11ac standard. The access points receive information relating to their neighbouring access points along with their signal strength by scanning the available wireless band for a fixed time period or by static configuration. However, the static provisioning of wireless channel width poses certain limitations, one of which is overlap of wireless channels between two or more neighbouring access points due to scarcity of independent channels with the statically configured channel width value.

In an exemplary event of static configuration of 80 MHz channel width mode created for four access points that are neighbour to each other, and the access points operate in an area/wireless band that allows only three independent 80 MHz wide channels. In such events, first two of the four access points will be allotted 2 separate channels of 80 MHz width; however, since there are only three available independent channels, the remaining two access points will share a common 80 MHz channel. This results in conflict between corresponding Base Service Stations (BSS) hosted by these two access points. The IEEE 802.11ac standard has specified a solution/technique to overcome the limitations occurred in static configuration by providing a mechanism to share a wide channel between two or more access points in an efficient manner. However, this mechanism is implemented only on firmware, and therefore may not be present on all wireless device for wireless services/operations.

Another limitation of the static provisioning of wireless bandwidth relates to underutilization of available wireless band. In an exemplary event of static configuration of 20 MHz channel width mode created for four access points that are neighbour to each other, and the access points operate in an area where 120 MHz available spectrum comprises of six consecutive standard 20 MHz channels. In such events, four out of six independent 20 MHz wide channels are assigned to four of the APs, thereby resulting in 2 unassigned 20 MHz wide channels. Therefore, the unutilized 40 MHz bandwidth reduces total aggregate throughput.

Further, in conventional art, the access points to which multiple wireless channels have to be allocated do not directly communicate with to each other resulting in involvement of a central entity/third party which regulates and helps in allocating the wireless channels to the access points. However, this approach/technique is less cost effective and poses certain limitations, inter alia, the central entity makes a common decision for each of the access point irrespective of the nature of the access points.

Accordingly, in order to overcome the aforementioned problems inherent in the existing solutions for allocating bandwidth to access points, there exists a need of an efficient mechanism to allocate the wireless channels to a plurality of wireless access points located in the available wireless band in an optimum manner without using any central entity/third party.

### SUMMARY

This section is provided to introduce certain objects and aspects of the present disclosure in a simplified form that are further described below in the detailed description. This summary is not intended to identify the key features or the scope of the claimed subject matter.

Embodiments of the present disclosure may relate to a method for a method for allocating at least one wireless channel to an access point, the method being performed by at least one of a plurality of access points, the method comprising: detecting at least one neighbouring access point operating within at least one available wireless spectrum; selecting at least one target wireless channel from a plurality of wireless channels present within the at least one available wireless spectrum, wherein the at least one target wireless channel is selected from the plurality of wireless channels which has the highest associated channel width; transmitting a request message to each of the at least one neighbouring access point to check if each of the at least one target wireless channel having the associated channel width is acceptable to the at least one neighbouring access point; receiving one of a positive response and a negative response from each of the at least one neighbouring access point, wherein the positive response is received in an event each of the at least one target wireless channel having the associated channel width is acceptable to the at least one neighbouring access point, and the negative response is received in an event each of the at least one target wireless channel having the associated channel width is not acceptable to the at least one neighbouring access point; and allocating the at least one target wireless channel having the associated channel width, in an event the positive response is received from each of the at least one neighbouring access point.

Further, the embodiments of the present disclosure encompass a system for allocating at least one wireless channel to an access point, the system comprising: a plurality of access points comprising: a selection module configured to: detect at least one neighbouring access point operating within at least one available wireless spectrum, and select at least one target wireless channel from a plurality of wireless channels present within the at least one available wireless spectrum, wherein the at least one target wireless channel is selected from the plurality of wireless channels which has the highest associated channel width; an evaluation module configured to: check if each of the at least one target wireless channel having the associated channel width is acceptable to the at least one neighbouring access point by transmitting a request message to each of the at least one neighbouring access point; and a communication module configured to: receive one of a positive response and a negative response from each of the at least one neighbouring access point, wherein the positive response is received in an event each of the at least one target wireless channel having the associated channel width is acceptable to the at least one neighbouring access point, and the negative response is received in an event each of the at least one target wireless channel having the associated channel width is not acceptable to the at least one neighbouring access point; and allocate the at least one target wireless channel having the associated channel width, in an event the positive response is received from each of the at least one neighbouring access point.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components.

FIG. 1 illustrates system architecture of an exemplary communication wireless network [100] for allocating at least one wireless channel to an access point in accordance with an embodiment of the present disclosure.

FIG. 2 illustrates an exemplary channelization scheme [200] for allocating at least one wireless channel to an access point in accordance with an embodiment of the present disclosure based on the IEEE 802.11ac standard.

FIG. 3 illustrates an exemplary access point [for e.g. 102A] deployed in the wireless network for allocating at least one wireless channel to an access point in accordance with an embodiment of the present disclosure.

FIG. 4 illustrates an exemplary method flow diagram [400] comprising the method steps being performed by the access point itself for allocating at least one wireless channel to the access point in accordance with an embodiment of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only one of the problems discussed above. Some of the problems discussed above might not be fully addressed by any of the features described herein. Example embodiments of the present disclosure are described below, as illustrated in various drawings in which like reference numerals refer to the same parts throughout the different drawings.

Embodiments of the present disclosure may relate to a mechanism for allocating at least one wireless channel to an access point that provides wireless services in a hotspot deployment environment. Each access point may be configured to identify at least one available wireless spectrum consisting of a plurality of wireless channels operating within the at least one available wireless spectrum. Also, each access point may be configured to detect at least one neighbouring access point within the at least one available wireless spectrum. Further, if the access point detects the at least one neighbouring access point, the access point selects at least one target wireless channel. Furthermore, the access point transmits a request message to each of the at least one neighbouring access point and subsequently allocates the at least one target channel to the neighbouring access points based on the response received by the at least one neighbouring access.

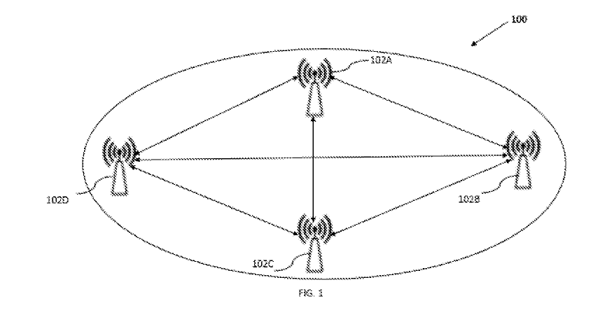

FIG. 1 illustrates an exemplary embodiment of the present disclosure which encompasses a system architecture for allocating at least one wireless channel to an access point. The system [100] may comprise at least one access point [for e.g. 102A] and at least one neighbouring access point [for e.g. 102B, 102C, 102D], wherein the at least one access point [for e.g. 102A] and the at least one neighbouring access point [for e.g. 102B, 102C, 102D] may be connected to each other through a communication channel of one of an internet or a private network.

The at least one access point [for e.g. 102A] may be deployed in a hotspot wireless area to provide wireless services in the area. In a preferred embodiment, the at least one access point [for e.g. 102A] is compliant to the IEEE 802.11ac standard and therefore operates on various wireless channel widths specified in the IEEE 802.11ac standard, including, but not limiting to, 20 MHz, 40 MHz, 80 MHz and 160 MHz. Additionally, the at least one access point [for e.g. 102A] has a maximum operating channel width as specified in the IEEE 802.11ac standard to provide wireless services in the area. Further, the at least one access point [for e.g. 102A] present within the wireless area, may be configured to detect at least one neighbouring access point [for e.g. 102B, 102C, 102D] that are not allocated to any wireless channel, but are present within a coverage area of the at least one access point [for e.g. 102A], wherein the coverage area of the at least one access point [for e.g. 102A] is the maximum distance from the access points up to which the signal from the access points is within an acceptable limit. Further, the at least one access point [for e.g. 102A] may be configured to receive information relating to the at least one neighbouring access point [for e.g. 102B, 102C, 102D] either by scanning the available wireless area for a fixed time period or by static configuration, wherein the information includes, but is not limited to, a signal strength of the at least one neighbouring access point [for e.g. 102B, 102C, 102D], a MAC address, a count of wireless channels and the maximum operating channel width of the at least one access point [for e.g. 102A]. For example and as illustrated in FIG. 1, the access point [102A] receives the information from the one or more neighbouring access points [for e.g. 102B, 102C and 102D] present within the coverage area of the at least one access point [for e.g. 102A].

Further, the at least one access point [for e.g. 102A] may be configured to obtain a plurality of wireless channels from the at least one available wireless spectrum, wherein the plurality of wireless channels is obtained by removing at least one of the wireless channels which are already allocated to at least one of the plurality of neighbouring access points and the wireless channels which are already being rejected by the at least one neighbouring access point [for e.g. 102B, 102C and 102D], wherein each of the plurality of wireless channels has an associated channel width along with a starting frequency and an ending frequency. In a preferred embodiment, the associated channel width is a multiple of 20 MHz based on the IEEE 802.11ac standard.

Subsequently, the at least one access point [for e.g. 102A] may be configured to select at least one target wireless channel from the plurality of wireless channels which has the highest comparative associated channel width. Therefore, the at least one target wireless channel has the highest channel width among the plurality of wireless channels, wherein the highest channel width is also a multiple of 20 MHz based on the IEEE 802.11ac standard.

The at least one access point [for e.g. 102A] may be further configured to transmit a request message to each of the at least one neighbouring access point [for e.g. 102B, 102C and 102D] to check if each of the at least one target wireless channel having the highest comparative associated channel width is acceptable to the at least one neighbouring access point [for e.g. 102B, 102C and 102D]. Subsequently, the at least one access point [for e.g. 102A] receives one of a positive response and a negative response from each of the at least one neighbouring access point [for e.g. 102B, 102C and 102D], wherein the positive response is received in an event each of the at least one target wireless channel having the highest comparative associated channel width is acceptable to the at least one neighbouring access point [for e.g. 102B, 102C and 102D], and the negative response is received in an event each of the at least one target wireless channel having the highest comparative associated channel width is not acceptable to the at least one neighbouring access point [for e.g. 102B, 102C and 102D].

In an embodiment, the at least one access point [for e.g. 102A] may be configured to receive the response, either positive or negative, from each of the at least one neighbouring access point [for e.g. 102B, 102C and 102D] for a pre-defined time interval. Therefore, the at least one access point [for e.g. 102A] rejects any response received after the completion of the time interval. Further, in another embodiment where the positive response is not received from each neighbouring access point [for e.g. 102B, 102C and 102D], the at least one access point [for e.g. 102A] may be configured to re-initiate the detection process and re-attempt to select a new target wireless channel having the highest channel width from the presently available plurality of wireless channels as compared to the channel width's of the currently selected at least one target wireless channel. Therefore, the new target wireless channel may now have the highest channel width. In an exemplary embodiment, the at least one access point [for e.g. 102A] may iterate the selecting process of the at least one target wireless channel only for a pre-defined count of selection attempts. Therefore, in an event the count of the selection attempt reaches the final value, the selected value of the at least one target wireless channel is considered. Subsequently, the at least one access point [for e.g. 102A] may update the target channel and the associated channel width.

Furthermore, the at least one access point [for e.g. 102A] may be configured to transmit a channel setting information to the at least one target wireless channel having the highest comparative associated channel width to each of the at least one neighbouring access point [for e.g. 102B, 102C and 102D], wherein the channel setting information includes, but is not limited to, a primary target channel number and the associated channel width that is selected for the allocation. In an embodiment, the channel setting information may be manually transmitted to each of the at least one neighbouring access point [for e.g. 102B, 102C and 102D], while in another embodiment, the channel setting information may be transmitted automatically to each of the at least one neighbouring access point [for e.g. 102B, 102C and 102D] through the communication channel of one of the internet or the private network.

On receiving the positive response from each of the at least one neighbouring access point [for e.g. 102B, 102C and 102D], the at least one access point [for e.g. 102A] may allocate at least one of the at least one target wireless channel to each of the at least one access point [for e.g. 102A] based on a channelization scheme for allocating the at least one wireless channel.

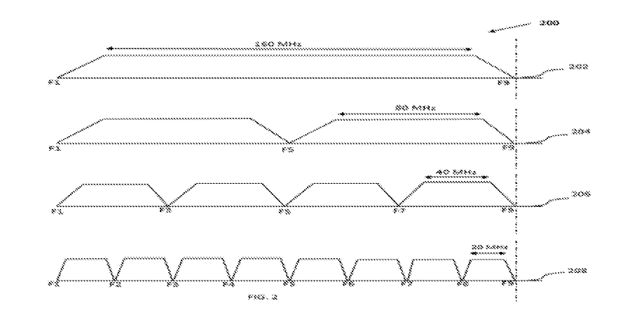

As illustrated in FIG. 2, the present disclosure encompasses an exemplary channelization scheme [200] for allocating the at least one wireless channel to the at least one access point [for e.g. 102A] based on the IEEE 802.11ac standard by fragmenting a wireless spectrum. Following may be the possibilities [202, 204, 206 and 208] of fragmentation for a 160 MHz wireless spectrum into a number of wireless channels based on the one or more neighbouring access points such that each wireless channel is allocated to at least one access point [for e.g. 102A], wherein each wireless channel has a starting frequency, an ending frequency and the channel width:

1. [202]: 1 channel (F1-F9) having the channel width of 160 MHz;
2. [204]: 2 channels (F1-F5 and F5-F9) having the channel width of 80 MHz;
3. [206]: 4 channels (F1-F3, F3-F5, F5-F7 and F7-F9) having the channel width of 40 MHz; and
4. [208]: 8 channels (F1-F2, F2-F3, F3-F4, F4-F5, F5-F6. F6-F7, F7-F8 and F8-F9) having the channel width of 20 MHz.

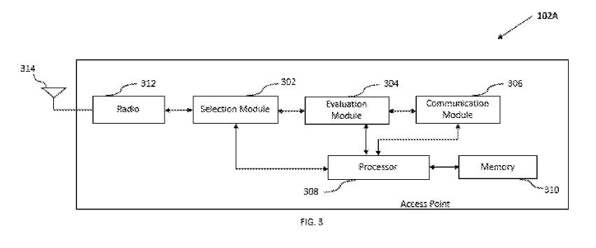

As illustrated in FIG. 3, the present disclosure encompasses a system architecture [300] for an exemplary access point [for e.g. 102A] deployed in the wireless network for allocating at least one wireless channel to the access point [for e.g. 102A]. The access point [for e.g. 102A] operates on multiple wireless channel widths as specified in the IEEE 802.11ac standard in order to provide wireless services in the area. Additionally, the access point [for e.g. 102A] has the maximum operating channel width as specified in the IEEE 802.11ac standard to provide wireless services in the area. Further, the access point [for e.g. 102A] may comprise a selection module [302], an evaluation module [304], a communication module [306], a cellular radio [312] connected with an antenna [314], a processor [308] and a memory [310].

The selection module [302] of the access point [for e.g. 102A] may be configured to detect at least one neighbouring access point [for e.g. 102B, 102C, 102D] that are not allocated to any wireless channel, but are present within the coverage area of the at least one access point [for e.g. 102A], wherein the coverage area of the at least one access point [for e.g. 102A] is the maximum distance from the access points up to which the signal from the access points is within acceptable limit. On detecting the at least one neighbouring access point [for e.g. 102B, 102C, 102D], the selection module [302] may be further configured to receive information relating to the at least one neighbouring access point [for e.g. 102B, 102C, 102D], either by scanning the available wireless area for a fixed time period or by static configuration, wherein the information includes, but is not limited to, a signal strength of the at least one neighbouring access point [for e.g. 102B, 102C, 102D], a MAC address, a count of wireless channels and the maximum operating channel width of the at least one access point [for e.g. 102A].

Further, the selection module [302] of the access point [for e.g. 102A] may be configured to obtain a plurality of wireless channels from the at least one available wireless spectrum, wherein the plurality of wireless channels is obtained by removing at least one of the wireless channels which are already allocated to at least one of the plurality of neighbouring access points and the wireless channels which are already rejected by the at least one neighbouring access point, wherein each of the plurality of wireless channels has an associated channel width along with the starting frequency and the ending frequency. In a preferred embodiment, the associated channel width is a multiple of 20 MHz based on the 802.11ac standard. Additionally, the selection module [302] may be configured to select at least one target wireless channel from the plurality of wireless channels which has the highest comparative associated channel width. Therefore, the at least one target wireless channel has the highest channel width among the plurality of wireless channels.

Further, the evaluation module [304] of the access point [for e.g. 102A], connected to the selection module [302] may be configured to transmit a request message to each of the at least one neighbouring access point [for e.g. 102B, 102C and 102D] to check if each of the at least one target wireless channel having the highest comparative associated channel width is acceptable to the at least one neighbouring access point [for e.g. 102B, 102C and 102D]. The evaluation module [304] is further connected to the communication module [306].

Subsequently, the communication module [306] of the access point [for e.g. 102A] may be configured to receive one of the positive response and the negative response from each of the at least one neighbouring access point [for e.g. 102B, 102C and 102D], wherein the positive response is received in an event each of the at least one target wireless channel having the highest comparative associated channel width is acceptable to the at least one neighbouring access point [for e.g. 102B, 102C and 102D], and the negative response is received in an event each of the at least one target wireless channel having the highest comparative associated channel width is not acceptable to the at least one neighbouring access point [for e.g. 102B, 102C and 102D]. In an embodiment, the communication module [306] may be configured to receive the response, either positive or negative, from each of the at least one neighbouring access point [for e.g. 102B, 102C and 102D] for a pre-defined time interval. Therefore, the communication module [306] rejects any response received after the completion of the time interval. Further, in another embodiment where the positive response is not received from each neighbouring access point [for e.g. 102B, 102C and 102D], the communication module [306] may be configured to re-initiate the detection process and re-attempt to select a new target wireless channel having the highest channel width from the presently available plurality of wireless channels as compared to the channel width's of the currently selected at least one target wireless channel. Therefore, the new target wireless channel may now have the highest channel width. In an exemplary embodiment, the communication module [306] may iterate the selecting process of the at least one target wireless channel only for a pre-defined count of selection attempts. Therefore, in an event the count of the selection attempt reaches the final value, the selected value of the at least one target wireless channel is considered.

Subsequently, the communication module [306] may update the target channel and the associated channel width.

Furthermore, the communication module [306] may be configured to transmit a channel setting information to the at least one target wireless channel having the highest comparative associated channel width to each of the at least one neighbouring access point [for e.g. 102B, 102C and 102D], wherein the channel setting information includes, but is not limited to, a primary target channel number and the associated channel width that is selected for the allocation. In an embodiment, the channel setting information may be manually transmitted to each of the at least one neighbouring access point [for e.g. 102B, 102C and 102D], while in another embodiment, the channel setting information may be transmitted automatically to each of the at least one neighbouring access point [for e.g. 102B, 102C and 102D] through the communication channel of one of the internet or the private network, wherein the communication channel is used to transmit and/or receive information/data relating to receive information relating to the at least one neighbouring access point [for e.g. 102B, 102C and 102D] using communication module [306] which may be a Ethernet port.

On receiving the positive response from each of the at least one neighbouring access point [for e.g. 102B, 102C and 102D] via the communication module [306], the evaluation module [304] may allocate at least one of the at least one target wireless channel to each of the at least one access point [for e.g. 102A] based on the channelization scheme for allocating the at least one wireless channel.

Further, the processor [308] may be connected with the selection module [302], the evaluation module [304] and the communication module [306] in order to process at least one of the information relating to the at least one neighbouring access points [for e.g. 102B, 102C and 102D] along with the associated signal strength and the channel setting information. The processor [308] as used herein may include, but is not limited to, processor or set of processors configured to perform operations, such as, for example, a microprocessor, a multi-core microprocessor, a digital signal processor, a collection of electronic circuits, or a combination thereof.

The access point [for e.g. 102A] may also include the cellular radio [312] transmission/reception radio frequency (RF) connected to the antenna [314] for receiving and transmitting wireless services such as VoIP and Internet/Intranet services, communicatively coupled to a modulation/demodulation circuit configured to extract information from RF signals received via the RF antenna and provide it to processor [308], or encode information received from the processor [308] into RF signals transmitted by the RF antenna. In an exemplary embodiment, the communication module [306] of the access point [for e.g. 102A] may be implemented using a Ethernet port. The cellular radio may be selected from a wide range of frequency bands based on the IEEE 802.11 standard, wherein the frequency bands include, but are not limited to, 800 MHz, 900 MHz, 1800 MHz, 2100 MHz and 2300 MHz, etc.

The memory [310], connected with the processor [308], may be configured to store and maintain at least one of the information relating to the at least one neighbouring access points [102B, 102C and 102D] along with the associated signal strength and channel setting information. The memory [310] may include, but not limited to, a volatile memory, non-volatile memory, a remote storage, a cloud storage, high-speed random access memory and/or non-volatile memory, such as one or more magnetic disk storage devices, one or more optical storage devices, and/or flash memory (e.g., NAND, NOR) or a combination thereof.

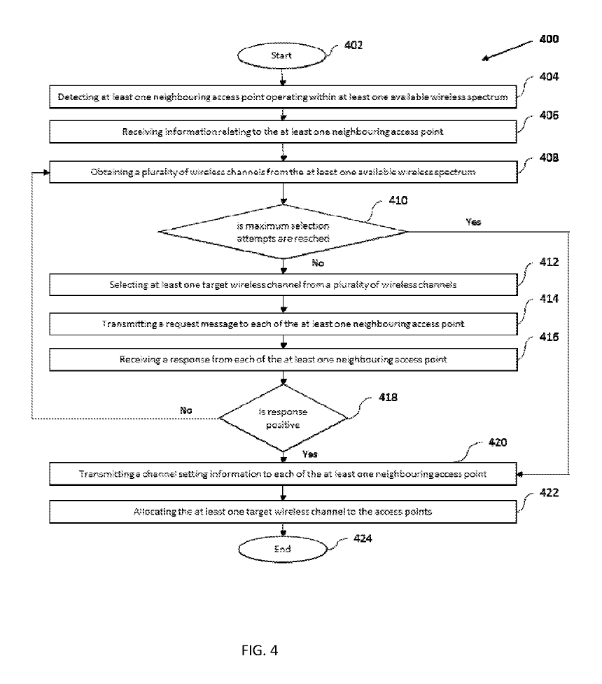

As illustrated in FIG. 4, the present disclosure encompasses an exemplary method [400] for allocating the at least one wireless channel to the access point in accordance with an embodiment of the present disclosure, wherein the method may be performed at the at least one access point [for e.g. 102A]. The following includes detailed steps involved in allocation of the at least one wireless channel, wherein the method step initiates at step 402.

At step 404, the at least one access point [for e.g. 102A] may be configured to detect at least one neighbouring access point [for e.g. 102B, 102C, 102D] that are not allocated to any wireless channel, but are present within the coverage area of the at least one access point [for e.g. 102A].

At step 406, the at least one access point [for e.g. 102A] may receive information relating to the at least one neighbouring access point [for e.g. 102B, 102C, 102D], either by scanning the available wireless area for the fixed time period or by the static configuration.

At step 408, the at least one access point [for e.g. 102A] may obtain a plurality of wireless channels from the at least one available wireless spectrum, wherein the plurality of wireless channels is obtained by removing at least one of the wireless channels which are already allocated to at least one of the plurality of neighbouring access points and the wireless channels which are already rejected by the at least one neighbouring access point [for e.g. 102B, 102C, 102D], wherein each of the plurality of wireless channels has an associated channel width along with the starting frequency and the ending frequency.

At step 410, the at least one access point [for e.g. 102A] may iterate the process of obtaining the plurality of wireless channels as discussed in above step for a pre-defined count of selection attempts. In an event the count of the selection attempt reaches the maximum value, the method [400] may lead to step 420. On the contrary, the method [400] may lead to step 412.

At step 412, the at least one access point [for e.g. 102A] may select at least one target wireless channel from the plurality of wireless channels which has the highest comparative associated channel width. Therefore, the at least one target wireless channel has the highest channel width among the plurality of wireless channels.

At step 414 and pursuant to accomplishment of the step 410, the at least one access point [for e.g. 102A] may transmit a request message to each of the at least one neighbouring access point [for e.g. 102B, 102C and 102D] to check if each of the at least one target wireless channel having the highest comparative associated channel width is acceptable to the at least one neighbouring access point [for e.g. 102B, 102C and 102D].

At step 416, the at least one access point [for e.g. 102A] may receive one of a positive response and a negative response from each of the at least one neighbouring access point [102B, 102C and 102D].

At step 418, the at least one access point [for e.g. 102A] may determine the positive and the negative response. In an event the positive response is received indicating that each of the at least one target wireless channel having the highest comparative associated channel width is acceptable to the at least one neighbouring access point [for e.g. 102B, 102C, 102D], the method [400] may proceed to step 418. Alternately, the method [400] may lead to step 410. In an embodiment, the at least one access point [for e.g. 102A] may be configured to receive the response, either positive or negative, from each of the at least one neighbouring access point [102B, 102C and 102D] for a pre-defined time interval. Therefore, the at least one access point [for e.g. 102A] rejects any response received after the completion of the time interval. Further, in another embodiment where the positive response is not received from each neighbouring access point [for e.g. 102B, 102C and 102D], the at least one access point [for e.g. 102A] is configured to re-initiate the detection process and re-attempt to select a new target wireless channel having the highest channel width from the presently available plurality of wireless channels as compared to the channel width/s of the currently selected at least one target wireless channel. Therefore, the new target wireless channel may now have the highest channel width. In an exemplary embodiment, the at least one access point [for e.g. 102A] may iterate the selecting process of the at least one target wireless channel only for a pre-defined count of selection attempts. Therefore, in an event the count of the selection attempt reaches the final value, the selected value of the at least one target wireless channel is considered. Subsequently, the at least one access point [for e.g. 102A] may update the target channel and the associated channel width.

At step 420, the at least one access point [for e.g. 102A] may transmit a channel setting information to the at least one target wireless channel having the highest comparative associated channel width to each of the at least one neighbouring access point [for e.g. 102B, 102C and 102D]. In an embodiment, the channel setting information may be manually transmitted, while in another embodiment, the channel setting information may be automatically transmitted to each of the at least one neighbouring access point [for e.g. 102B, 102C and 102D] through the communication channel of one of the internet or the private network, wherein the communication channel is used to transmit and/or receive information/data relating to receive information relating to the at least one neighbouring access point [for e.g. 102B, 102C and 102D] using communication module [306] which may be a Ethernet port.

At step 422, the at least one access point [for e.g. 102A] may allocate at least one of the at least one target wireless channel to each of the at least one access point [for e.g. 102A] based on the channelization scheme for allocating the at least one wireless channel.

At step 424, the method [400] terminates with the allocation of the at least one target wireless channel to the at least one access point [for e.g. 102A].

Though a limited number of the access points [102A, 102B, 102C and 102D], the neighbouring access points and the links/connections/interfaces, have been shown in the figures; however, it will be appreciated by those skilled in the art that the system [100] of the present disclosure encompasses any number and varied types of the entities/elements such as the interfaces, the access points [102A, 102B, A03C and 102D] and the neighbouring access points.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

We claim:

1. A method for allocating at least one wireless channel to an access point, the method being performed by at least one of a plurality of access points, the method comprising:
detecting at least one neighbouring access point [for e.g. 102B, 102C and 102D] operating within at least one available wireless spectrum;
selecting at least one target wireless channel from a plurality of wireless channels present within the at least one available wireless spectrum, wherein the at least one target wireless channel is selected from the plurality of wireless channels which has the highest associated channel width;
transmitting a request message to each of the at least one neighbouring access point [for e.g. 102B, 102C and 102D] to check if each of the at least one target wireless channel having the associated channel width is acceptable to the at least one neighbouring access point [for e.g. 102B, 102C and 102D];
receiving one of a positive response and a negative response from each of the at least one neighbouring access point [for e.g. 102B, 102C and 102D], wherein
the positive response is received in an event each of the at least one target wireless channel having the associated channel width is acceptable to the at least one neighbouring access point [for e.g. 102B, 102C and 102D], and the negative response is received in an event each of the at least one target wireless channel having the associated channel width is not acceptable to the at least one neighbouring access point [for e.g. 102B, 102C and 102D]; and
allocating the at least one target wireless channel having the associated channel width, in an event the positive response is received from each of the at least one neighbouring access point [for e.g. 102B, 102C and 102D].

2. The method as claimed in claim 1, further comprising transmitting a channel setting information of the at least one target wireless channel having the associated channel width to each of the at least one neighbouring access point [for e.g. 102B, 102C and 102D] which transmits the positive response.

3. The method as claimed in claim 2, wherein the channel setting information comprising a primary target channel number having the associated channel width.

4. The method as claimed in claim 1, wherein the plurality of access points has a maximum operating channel width.

5. The method as claimed in claim 4, wherein the maximum operating channel width is maximum channel width based on an 802.11 standard.

6. The method as claimed in claim 1, wherein the plurality of wireless channels is obtained by removing at least one of the wireless channels which are already allocated to at least one of the plurality of neighbouring access points and the wireless channels which are already rejected by the at least one neighbouring access point [for e.g. 102B, 102C and 102D].

7. The method as claimed in claim 1, wherein the maximum channel width is a multiple of 20 MHz based on the 802.11 standard.

8. The method as claimed in claim 1, wherein the at least one neighbouring access point [for e.g. 102B, 102C and 102D] is present within a coverage area of the plurality of access points.

9. The method as claimed in claim 1, wherein the request message comprising the at least one target wireless channel along with the associated channel width.

10. The method as claimed in claim 1, wherein the plurality of access points receive one of the positive response and the negative response within a pre-defined time interval.

11. A system for allocating at least one wireless channel to an access point, the system comprising:
a plurality of access points comprising:
a selection module [302] configured to:
detect at least one neighbouring access point [for e.g. 102B, 102C and 102D] operating within at least one available wireless spectrum, and select at least one target wireless channel from a plurality of wireless channels present within the at least one available wireless spectrum, wherein the at least one target wireless channel is selected from the plurality of wireless channels which has the highest associated channel width;
an evaluation module [304] configured to:
check if each of the at least one target wireless channel having the associated channel width is acceptable to the at least one neighbouring access point [for e.g. 102B, 102C and 102D] by transmitting a request message to each of the at least one neighbouring access point [for e.g. 102B, 102C and 102D]; and
a communication module [306] configured to:
receive one of a positive response and a negative response from each of the at least one neighbouring access point [for e.g. 102B, 102C and 102D], wherein
the positive response is received in an event each of the at least one target wireless channel having the associated channel width is acceptable to the at least one neighbouring access point [for e.g. 102B, 102C and 102D], and
the negative response is received in an event each of the at least one target wireless channel having the associated channel width is not acceptable to the at least one neighbouring access point [for e.g. 102B, 102C and 102D]; and
allocate the at least one target wireless channel having the associated channel width, in an event the positive response is received from each of the at least one neighbouring access point [for e.g. 102B, 102C and 102D].

12. The system as claimed in claim 11, wherein the communication module [306] is further configured to transmit a channel setting information of the at least one target wireless channel having the associated channel width to each of the at least one neighbouring access point [for e.g. 102B, 102C and 102D] which transmits the positive response.

13. The method as claimed in claim 12, wherein the channel setting information comprising a primary target channel number having the associated channel width.
